(19) United States
(12) Patent Application Publication
(10) Pub. No.: US 2026/0167350 A1
(43) Pub. Date: Jun. 18, 2026

(54) INFORMATION PROCESSING APPARATUS, METHOD FOR PROVIDING TRANSPORTATION, AND NON-TRANSITORY COMPUTER READABLE MEDIUM

(71) Applicant: TOYOTA JIDOSHA KABUSHIKI KAISHA, Aichi-ken (JP)

(72) Inventor: Daiki KANEICHI, Tokyo-to (JP)

(21) Appl. No.: 19/396,339

(22) Filed: Nov. 21, 2025

(30) Foreign Application Priority Data
Dec. 13, 2024 (JP) 2024-219422

(51) Int. Cl. B64F 1/36; G06Q 10/02

(52) U.S. Cl. CPC B64F 1/368; G06Q 10/02

(57) ABSTRACT

An information processing apparatus includes a controller. The controller acquires information regarding a departure point and a destination specified by a user, determines an aircraft, a departure port, and an arrival port to be used in a travel route from the departure point to the destination, based on a management database for transportation reservations, and determines a first vehicle to be used for travel from the departure point to the departure port, based on inspection equipment information regarding the departure port.

### CROSS-REFERENCE TO RELATED APPLICATION

This application claims priority to Japanese Patent Application No. 2024-219422 filed on Dec. 13, 2024, the entire contents of which are incorporated herein by reference.

### TECHNICAL FIELD

The present disclosure relates to an information processing apparatus, a method for providing transportation, and a program.

### BACKGROUND

Technology for installing, in aircraft, power receiving apparatuses that receive power by non-contact power supply using magnetic resonance and thrust generation mechanisms that obtain thrust for flight using the power received by the power receiving apparatuses is disclosed. For example, see Patent Literature (PTL) 1.

### CITATION LIST

### Patent Literature

PTL 1: WO 2017/203590 A1

### SUMMARY

Technology for providing services (hereinafter also referred to as Flying Mobility services) that include travel of users by aircraft has not been studied at all. On the other hand, it is desired to provide seamless travel experience that improves the convenience of the entire travel through Flying Mobility services. Thus, there is room for improvement in the technology for providing Flying Mobility services.

It would be helpful to improve technology for providing Flying Mobility services.

An information processing apparatus according to an embodiment of the present disclosure is an information processing apparatus including a controller configured to:
acquire information regarding a departure point and a destination specified by a user;
determine a route from the departure point to the destination, based on a management database for transportation reservations, the route including travel from a departure port to an arrival port by aircraft; and
determine a first vehicle to be used for travel from the departure point to the departure port, based on information regarding the presence or absence of inspection equipment at the departure port.

According to an embodiment of the present disclosure, technology for providing Flying Mobility services is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating an overview of a travel route according to the embodiment of the present disclosure;

FIG. 3 is a diagram illustrating an overview of technology for providing transportation according to the embodiment of the present disclosure;

FIG. 4 is a block diagram illustrating a schematic configuration of an information processing apparatus according to the embodiment of the present disclosure;

FIG. 5 is a block diagram illustrating a management database for transportation reservations according to the embodiment of the present disclosure;

FIG. 6 is a block diagram illustrating a schematic configuration of a terminal apparatus;

FIG. 7 is a block diagram illustrating a schematic configuration of an aircraft;

FIG. 8 is a block diagram illustrating a schematic configuration of a first vehicle;

FIG. 9 is a block diagram illustrating a schematic configuration of a second vehicle;

FIG. 10 is a flowchart illustrating operations of the information processing apparatus according to the embodiment of the present disclosure;

FIG. 11 is an example of a user interface according to the embodiment of the present disclosure;

FIG. 12 is an example of the user interface according to the embodiment of the present disclosure;

FIG. 13 is an example of the user interface according to the embodiment of the present disclosure;

FIG. 14 is a flowchart illustrating check-in operations of the information processing apparatus according to the embodiment of the present disclosure; and

FIG. 15 is an example of the user interface according to the embodiment of the present disclosure.

### DETAILED DESCRIPTION

Hereinafter, an embodiment of the present disclosure will be described.

### Outline of Embodiment

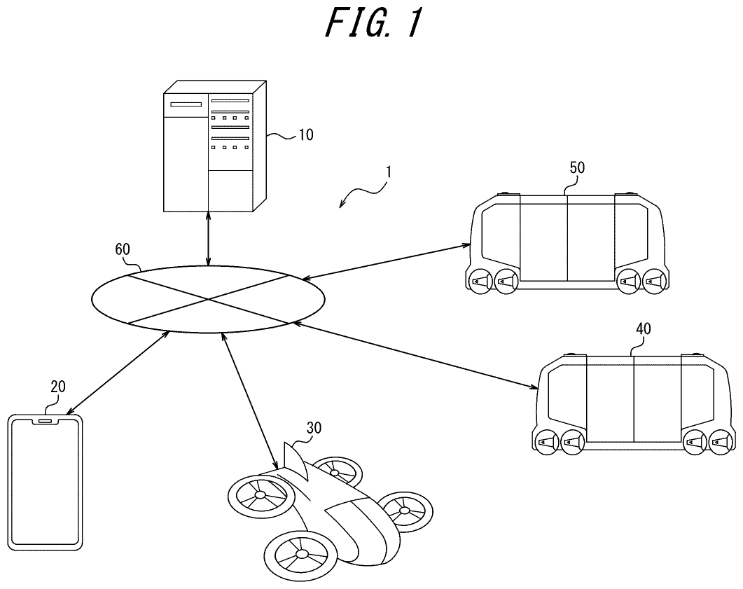

An outline of a system 1 according to the embodiment of the present disclosure will be described with reference to FIG. 1. The system 1 includes an information processing apparatus 10, a terminal apparatus 20, an aircraft 30, a first vehicle 40, and a second vehicle 50. The information processing apparatus 10, terminal apparatus 20, aircraft 30, first vehicle 40, and second vehicle 50 are communicably connected to a network 60 including, for example, the Internet and a mobile communication network.

The information processing apparatus 10 is a server device installed in, for example, a data center. For example, the information processing apparatus 10 is a server that belongs to a cloud computing system or other computing systems. The information processing apparatus 10 can communicate with the terminal apparatus 20, aircraft 30, first vehicle 40, and second vehicle 50 via the network 60. Although FIG. 1 shows an example where the information processing apparatus 10 included in the system 1 is one unit, this is not limited to that. The system 1 may include two or more information processing apparatuses 10.

The terminal apparatus 20 is any device used by users such as passengers of the aircraft 30. For example, general purpose electronic devices such as smartphones, tablet terminals, wearable devices, or dedicated electronic devices can be adopted as the terminal apparatus 20. Although FIG. 1 shows an example where the terminal apparatus 20 included in the system 1 is one unit, this is not limited to that. The system 1 may include two or more terminal apparatuses 20.

The aircraft 30 is, for example, a transport device that has electric rotors and flies on battery power. For example, the aircraft 30 is an eVTOL (electric Vertical Take Off and Landing). The eVTOL has a cabin of approximately the same size as a passenger car that can accommodate one or more occupants, and a mechanism that includes one or more electric rotors to generate lift and thrust. The eVTOL is piloted at least partially by visual flight rules (VFR). The aircraft 30 is not limited to eVTOLs and may include helicopters, airplanes, etc. The aircraft 30 has a drive mechanism, including a motor, to drive the electric rotors, a corresponding control unit, and a battery to supply electric power to the drive mechanism. The battery is, for example, a lithium-ion battery. The aircraft 30 may be piloted by instrument flight rules (IFR). The aircraft 30 may also be an unmanned aerial vehicle, a remotely piloted aircraft, etc.

The first vehicle 40 is an automobile, for example, but is not limited to this and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of the first vehicle 40 provided in the system 1 may be freely determined. In the present embodiment, the first vehicle 40 is assumed to be any autonomous vehicle that travels unmanned, but may also be a manned vehicle.

The second vehicle 50 is an automobile, for example, but is not limited to this and may be any appropriate vehicle. The automobile is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of the second vehicle 50 provided in the system 1 may be freely determined. In the present embodiment, the second vehicle 50 is assumed to be any autonomous vehicle that travels unmanned, but may also be a manned vehicle.

First, an outline of the present embodiment will be described, and details thereof will be described later. The method for providing transportation according to the present embodiment is executed by the information processing apparatus 10. The information processing apparatus 10 acquires information regarding the departure point and the destination specified by the user. The information processing apparatus 10 also determines the aircraft 30, departure port, and arrival port used in the travel route from the departure point to the destination based on a management database for transportation reservations. The information processing apparatus 10 also determines the first vehicle 40 used for the movement from the departure point to the departure port based on inspection equipment information regarding the departure port. Furthermore, the information processing apparatus 10 may determine the second vehicle 50 used for the movement from the arrival port to the destination based on the estimated arrival time of the aircraft 30 landing at the arrival port.

Thus, according to the present embodiment, the aircraft 30 used in the travel route based on the departure point and destination specified by the user is determined based on a management database for transportation reservations, and the first vehicle 40 is determined based on inspection equipment information regarding the departure port. Therefore, in terms of determining the optimal aircraft and vehicle according to the travel route, the technology for providing Flying Mobility services is improved.

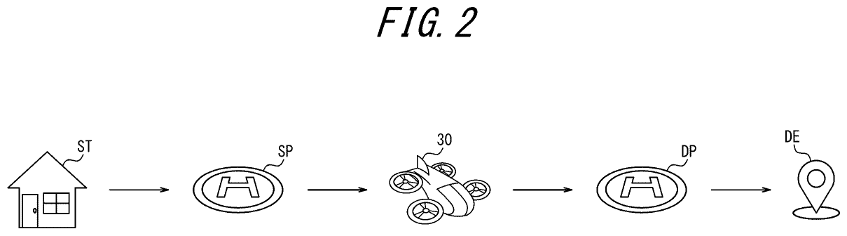

Referring to FIG. 2, an overview of the travel route according to the embodiment of the present disclosure is shown. The travel route shown in FIG. 2 is the movement path from the departure point ST to the destination DE. The travel route includes the departure port SP from which the aircraft 30 takes off and the arrival port DP where the aircraft 30 lands. The first vehicle 40 is used for the movement from the departure point ST to the departure port SP. The aircraft 30 is used for the movement from the departure port SP to the arrival port DP. The second vehicle 50 is used for the movement from the arrival port DP to the destination DE.

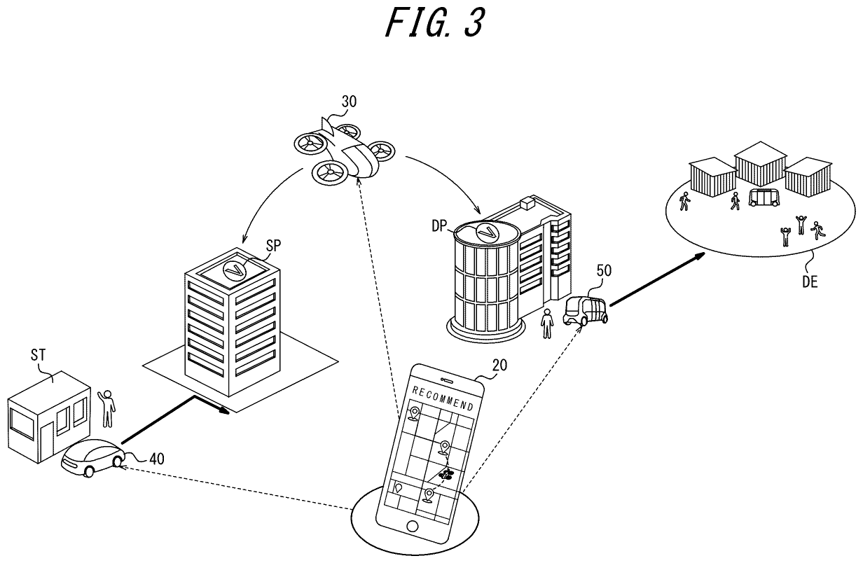

Referring to FIG. 3, an overview of the technology for providing transportation according to the embodiment of the present disclosure is shown. As an overview, the user can use the terminal apparatus 20 to arrange the aircraft 30, the first vehicle 40, and the second vehicle 50 through communication with the information processing apparatus 10, and move from the departure point ST to the destination DE. In the transportation means provision technology according to an embodiment of the present disclosure, the technology for providing Flying Mobility services is improved from the following four perspectives, for example.
(1) Optimal travel route setting from the departure point ST to the departure port SP.

As mentioned above, the information processing apparatus 10 determines the travel route from the user-specified departure point ST to the destination DE based on a management database for transportation reservations. This processing automatically sets the optimal boarding and alighting locations according to the destination DE, allowing the user to start moving smoothly. Here, the information processing apparatus 10 may set the optimal travel route according to user needs. In other words, the optimal travel route can be adjusted according to user needs. For example, the information processing apparatus 10 may set a route according to user needs such as means of transportation, destination, and number of passengers. Such means of transportation may include not only vehicles and aircraft but also any means of transportation such as walking, bicycles, trains, and electric kickboards.
(2) Smooth pre-boarding procedures and guidance.

As will be described later, the boarding procedures for the aircraft 30 may be carried out in advance in the first vehicle 40. This enables smooth boarding procedures for the aircraft 30. In other words, after the first vehicle 40 arrives at the departure port, the user can immediately board the aircraft 30.
(3) Experience of transferring to the second vehicle 50 with minimal waiting time.

As mentioned above, since the second vehicle is determined based on the estimated arrival time at the arrival port where the aircraft 30 lands, it can provide a transfer experience with minimal waiting time.
(4) Response in case of operational difficulties.

As will be described later, if the aircraft 30 is unable to operate due to bad weather or the like, a proposal for changing the travel route may be made. This allows for the provision of alternative means of transportation even when the aircraft 30 is unable to operate.

Next, configurations of the system 1 will be described in detail.

### Configuration of Information Processing Apparatus

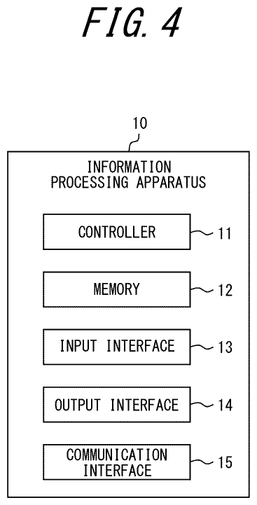

As shown in FIG. 4, the information processing apparatus 10 includes a controller 11, a memory 12, an input interface 13, an output interface 14, and a communication interface 15.

The controller 11 includes at least one processor, at least one dedicated circuit, or a combination thereof. The processor is a general purpose processor, such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The input interface 13 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 13 accepts an operation for inputting data to be used for the operations of the information processing apparatus 10. The input interface 13 may be connected to the information processing apparatus 10 as an external input device, instead of being included in the information processing apparatus 10. As a connection method, for example, any method such as Universal Serial Bus (USB), High-Definition Multimedia Interface (HDMI®; HDMI is a registered trademark in Japan, other countries, or both), or Bluetooth® (Bluetooth is a registered trademark in Japan, other countries, or both) can be used.

The output interface 14 includes at least one interface for output. The interface for output is, for example, a display for outputting information in the form of images, or a speaker for outputting information in the form of audio, or the like. The display is, for example, a liquid crystal display (LCD) or an organic electro luminescent (EL) display. The output interface 14 outputs data obtained by the operations of the information processing apparatus 10. The output interface 14 may be connected to the information processing apparatus 10 as an external output device, instead of being included in the information processing apparatus 10. As the connection method, any method such as USB, HDMI®, or Bluetooth® can be used.

The communication interface 15 includes at least one external communication interface. The interface for communication may be either a wired or wireless communication interface. For wired communication, the interface for communication is, for example, a Local Area Network (LAN) interface or Universal Serial Bus (USB). For wireless communication, the interface for communication may include, for example, an interface compliant with mobile communication standards such as Long Term Evolution (LTE), 4th generation (4G), or 5th generation (5G), an interface compliant with short-range wireless communication such as Bluetooth®, or satellite communication, etc. The communication interface 15 receives data to be used in the operations of the information processing apparatus 10, and transmits data obtained by the operations of the information processing apparatus 10.

The functions of the information processing apparatus 10 are realized by execution of a program according to the present embodiment by a processor corresponding to the controller 11. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

Some or all of the functions of the information processing apparatus 10 may be realized by a dedicated circuit corresponding to the controller 11. That is, some or all of the functions of the information processing apparatus 10 may be realized by hardware.

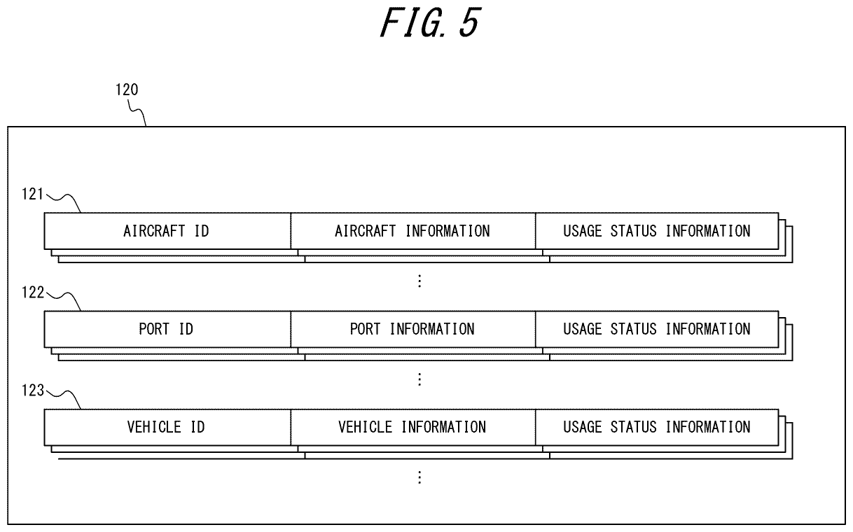

In the present embodiment, the memory 12 stores a management database related to transportation reservations. Referring to FIG. 5, an example of the management database related to transportation reservations is shown. The management database 120 in FIG. 5 includes various information related to the aircraft 30, departure port and arrival port, as well as the first vehicle 40 and the second vehicle 50. As shown in FIG. 5, the management database 120 includes an aircraft table 121, a port table 122, and a vehicle table 123. The aircraft table 121 is a table that manages the association of aircraft ID, aircraft information, and usage status information. The aircraft ID is identification information for uniquely identifying the aircraft. The aircraft information is various information related to the aircraft 30. Aircraft information may include the current location information, battery level information, speed information, flight altitude, status information of onboard equipment, maintenance history, etc. corresponding to the aircraft ID. Usage status information is information related to the current usage status of the aircraft corresponding to the aircraft ID and information related to flight reservations. Usage status information may include the current flight status (e.g., waiting, in operation, under maintenance), reservation information, reservation time slots, purpose of use, allowable baggage capacity, weight, next scheduled maintenance, etc.

The port table 122 includes information related to locations used as departure ports and arrival ports (hereinafter collectively referred to as ports). Specifically, the port table 122 includes a port ID, port information, and usage status information. The port ID is identification information for uniquely identifying the port. Port information is basic information about the port, which may include the port name, location (address or latitude and longitude), operator information, facility information (e.g., number of parking spaces, presence of charging stations), types of aircraft that can be accommodated, inspection equipment information, etc. Inspection equipment information is information regarding the presence or absence of inspection equipment at the port. Inspection equipment includes baggage inspection equipment and security inspection equipment. Usage status information is information indicating the current usage status of the port corresponding to the port ID. Usage status information may include the number of currently used aircraft, reservation status (e.g., the next aircraft scheduled for use, reserved time slots), availability of ports, maintenance information of equipment, etc.

The vehicle table 123 is a table that manages the first vehicle and the second vehicle (hereinafter collectively referred to as vehicles). Specifically, the vehicle table 123 is a table that manages the association of vehicle ID, vehicle information, and usage status information. The vehicle ID is identification information for uniquely identifying the vehicle. Vehicle information is basic information about the vehicle, which may include the type of vehicle corresponding to the vehicle ID, capacity, allowable baggage capacity, current location information of the vehicle, fuel or battery level, maintenance history of the vehicle, vehicle number, inspection equipment information, etc. Inspection equipment information is information regarding the presence or absence of inspection equipment mounted on the vehicle, including baggage inspection equipment and security inspection equipment. Usage status information is information indicating the current usage status of the vehicle corresponding to the vehicle ID. Usage status information may include the current operation status (e.g., waiting, in operation, under maintenance), operation reservation information, reservation information, destination information, next scheduled maintenance, vehicle operating time history, etc.

### Configuration of Terminal Apparatus

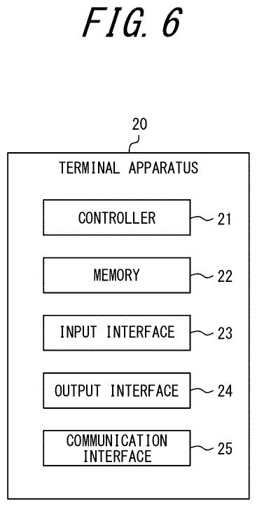

As shown in FIG. 6, the terminal apparatus 20 includes a controller 21, a memory 22, an input interface 23, an output interface 24, and a communication interface 25.

The controller 21 includes at least one processor, at least one dedicated circuit, or a combination thereof. The processor is a general purpose processor, such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 21 executes processes related to operations of the terminal apparatus 20 while controlling components of the terminal apparatus 20.

The memory 22 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 22 functions as, for example, a main memory, an auxiliary memory, or a cache memory. The memory 22 stores data to be used for the operations of the terminal apparatus 20 and data obtained by the operations of the terminal apparatus 20.

The input interface 23 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 23 accepts an operation for inputting data to be used for the operations of the terminal apparatus 20. The input interface 23 may be connected to the terminal apparatus 20 as an external input device, instead of being included in the terminal apparatus 20. As a connection method, for example, any method such as Universal Serial Bus (USB), High-Definition Multimedia Interface (HDMI®), or Bluetooth® can be used.

The output interface 24 includes at least one interface for output. The interface for output is, for example, a display for outputting information in the form of images, or a speaker for outputting information in the form of audio, or the like. The display is, for example, a liquid crystal display (LCD) or an organic electro luminescent (EL) display. The output interface 24 outputs data obtained by the operations of the terminal apparatus 20. The output interface 24 may be connected to the terminal apparatus 20 as an external output device, instead of being included in the terminal apparatus 20. As the connection method, any method such as USB, HDMI®, or Bluetooth® can be used.

The communication interface 25 includes at least one external interface for communication. The interface for communication may be either a wired or wireless communication interface. For wired communication, the interface for communication is, for example, a Local Area Network (LAN) interface or Universal Serial Bus (USB). For wireless communication, the interface for communication may include, for example, an interface compliant with mobile communication standards such as Long Term Evolution (LTE), 4th generation (4G), or 5th generation (5G), an interface compliant with short-range wireless communication such as Bluetooth®, or satellite communication, etc. The communication interface 25 receives data to be used for the operations of the terminal apparatus 20, and transmits data obtained by the operations of the terminal apparatus 20.

The functions of the terminal apparatus 20 are realized by execution of a program according to the present embodiment by a processor corresponding to the controller 21. That is, the functions of the terminal apparatus 20 are realized by software. The program causes a computer to execute the operations of the terminal apparatus 20, thereby causing the computer to function as the terminal apparatus 20. That is, the computer executes the operations of the terminal apparatus 20 in accordance with the program to thereby function as the terminal apparatus 20.

Some or all of the functions of the terminal apparatus 20 may be implemented by a dedicated circuit corresponding to the controller 21. That is, some or all of the functions of the terminal apparatus 20 may be realized by hardware.

### Configuration of Flight Object

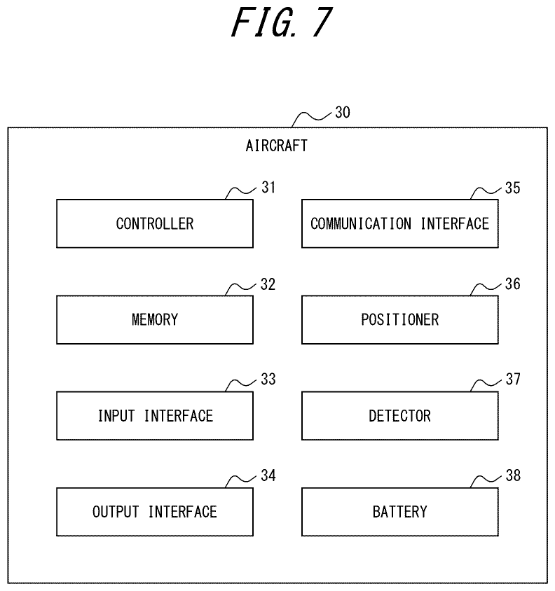

As illustrated in FIG. 7, the aircraft 30 includes a controller 31, a memory 32, an input interface 33, an output interface 34, a communication interface 35, a positioner 56, a detector 37, and a battery 38.

The controller 31 includes at least one processor, at least one dedicated circuit, or a combination thereof. The processor is a general purpose processor, such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 31 executes processes related to the operations of the aircraft 30 while controlling components of the aircraft 30. For example, the controller 31 controls a drive mechanism that includes a motor for driving the electric rotor blades.

The memory 32 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 32 functions as, for example, a main memory, an auxiliary memory, or a cache memory. The memory 32 stores data to be used for the operations of the aircraft 30 and data obtained by the operations of the aircraft 30.

The input interface 33 includes at least one interface for input. The interface for input is, for example, a physical key, a capacitive key, a pointing device, or a touch screen integrally provided with a display. The interface for input may be, for example, an audio sensor that accepts audio input, or a camera that accepts gesture input, or the like. The input interface 33 accepts an operation for inputting data to be used for the operations of the aircraft 30. The input interface 33 may be connected to the aircraft 30 as an external input device, instead of being provided in the aircraft 30. As a connection method, for example, any method such as Universal Serial Bus (USB), High-Definition Multimedia Interface (HDMI®), or Bluetooth® can be used.

The output interface 34 includes at least one interface for output. The interface for output is, for example, a display for outputting information in the form of images, or a speaker for outputting information in the form of audio, or the like. The display is, for example, a liquid crystal display (LCD) or an organic electro luminescent (EL) display. The output interface 34 outputs data obtained by the operations of the aircraft 30. The output interface 34 may be connected to the aircraft 30 as an external output device, instead of being included in the aircraft 30. As the connection method, any method such as USB, HDMI®, or Bluetooth® can be used.

The communication interface 35 includes at least one external interface for communication. The interface for communication may be either a wired or wireless communication interface. For wired communication, the interface for communication is, for example, a Local Area Network (LAN) interface or Universal Serial Bus (USB). In the case of wireless communication, the interface for communication may include, for example, an interface compliant with a mobile communication standard such as Long Term Evolution (LTE), 4th generation (4G), or 5th generation (5G), or an interface compliant with short-range wireless communication such as Bluetooth®, or satellite communication, etc. The communication interface 35 receives data to be used for the operations of the aircraft 30, and transmits data obtained by the operations of the aircraft 30.

The positioner 36 includes a sensor or receiver for acquiring the position of the aircraft 30 by autonomous navigation, electronic navigation, a global navigation satellite system (GNSS), or the like. Sensors for autonomous navigation include, for example, accelerometers, gyro-sensors, compasses, altimeters, and the like. Receivers for electronic navigation include, for example, VHF omni-directional radio range (VOR), instrument landing system (ILS), and other receivers for receiving radio waves from ground-based radio facilities. Furthermore, the GNSS receiver includes, for example, at least one of Global Positioning System (GPS), Quasi-Zenith Satellite System (QZSS), BeiDou, Global Navigation Satellite System (GLONASS), and Galileo receivers. The positioner 36 acquires the positional information for the aircraft 30 and transmits the positional information to the controller 31. Here, the positional information includes altitude information of the aircraft 30.

The detector 37 includes one or more sensors, or interfaces with sensors, that detect the condition or operation of various components in the aircraft 30 and transmits information indicating the results of detection by the sensors to the controller 31. The sensors include sensors that detect the state or operation of drive mechanisms including motors, propeller rotation speed, remaining battery charge of the battery 38, temperature, charging speed, and the like. The sensors also include wind speed sensors, wind direction sensors, air temperature sensors, air pressure sensors, humidity sensors, illumination sensors, rainfall sensors, cameras, and other sensors that detect conditions in the environment external to the aircraft 30.

The battery 38 supplies power to the drive mechanism of the aircraft 30. The battery 38 may be, for example, a lithium-ion battery, a solid electrolyte battery, a nickel-hydrogen battery, or the like.

### Configuration of the First Vehicle

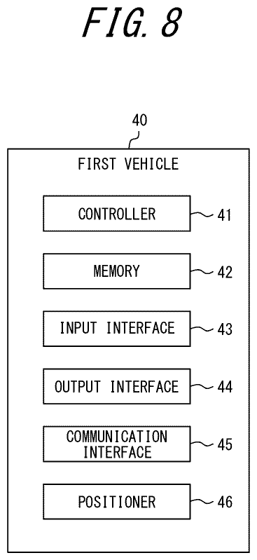

As illustrated in FIG. 8, the first vehicle 40 includes a controller 41, a memory 42, an input interface 43, an output interface 44, a communication interface 45, and a positioner 46.

The controller 41 includes at least one processor, at least one dedicated circuit, or a combination thereof. The processor is a general purpose processor, such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 41 executes processes related to the operations of the first vehicle 40 while controlling components of the first vehicle 40. For example, the controller 41 controls a drive mechanism that includes a motor for driving the electric rotor blades.

The memory 42 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 42 functions as, for example, a main memory, an auxiliary memory, or a cache memory. The memory 42 stores data to be used for the operations of the first vehicle 40 and data obtained by the operations of the first vehicle 40.

The input interface 43 includes at least one interface for input. The interface for input is, for example, a physical key, a capacitive key, a pointing device, or a touch screen integrally provided with a display. The interface for input may be, for example, an audio sensor that accepts audio input, or a camera that accepts gesture input, or the like. The input interface 43 accepts operations for inputting data to be used for the operations of the first vehicle 40. The input interface 43 may be connected to the first vehicle 40 as an external input device, instead of being provided in the first vehicle 40. As a connection method, for example, any method such as Universal Serial Bus (USB), High-Definition Multimedia Interface (HDMI®), or Bluetooth® can be used.

The output interface 44 includes at least one interface for output. The interface for output is, for example, a display for outputting information in the form of images, or a speaker for outputting information in the form of audio, or the like. The display is, for example, a liquid crystal display (LCD) or an organic electro luminescent (EL) display. The output interface 44 outputs data obtained by the operations of the first vehicle 40. The output interface 44 may be connected to the first vehicle 40 as an external output device, instead of being included in the first vehicle 40. As the connection method, any method such as USB, HDMI®, or Bluetooth® can be used.

The communication interface 45 includes at least one external communication interface. The interface for communication may be either a wired or wireless communication interface. For wired communication, the interface for communication is, for example, a Local Area Network (LAN) interface or Universal Serial Bus (USB). In the case of wireless communication, the interface for communication may include, for example, an interface compliant with a mobile communication standard such as Long Term Evolution (LTE), 4th generation (4G), or 5th generation (5G), or an interface compliant with short-range wireless communication such as Bluetooth®, or satellite communication, etc. The communication interface 45 receives data to be used for the operations of the first vehicle 40, and transmits data obtained by the operations of the first vehicle 40.

The positioner 46 includes one or more sensors or receivers for acquiring the position information of the first vehicle 40 by GNSS (Global Navigation Satellite System) or the like. The GNSS receiver includes, for example, at least one of Global Positioning System (GPS), Quasi-Zenith Satellite System (QZSS), BeiDou, Global Navigation Satellite System (GLONASS), and Galileo.

### Configuration of Second Vehicle

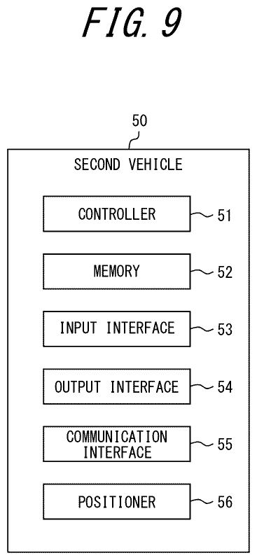

As illustrated in FIG. 9, the second vehicle 50 includes a controller 51, a memory 52, an input interface 53, an output interface 54, a communication interface 55, and a positioner 56.

The controller 51 includes at least one processor, at least one dedicated circuit, or a combination thereof. The processor is a general purpose processor, such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 51 executes processes related to the operations of the second vehicle 50 while controlling components of the second vehicle 50. For example, the controller 51 controls a drive mechanism that includes a motor for driving the electric rotor blades.

The memory 52 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 52 functions as, for example, a main memory, an auxiliary memory, or a cache memory. The memory 52 stores data to be used for the operations of the second vehicle 50 and data obtained by the operations of the second vehicle 50.

The input interface 53 includes at least one interface for input. The interface for input is, for example, a physical key, a capacitive key, a pointing device, or a touch screen integrally provided with a display. The interface for input may be, for example, an audio sensor that accepts audio input, or a camera that accepts gesture input, or the like. The input interface 53 accepts operations for inputting data to be used for the operations of the second vehicle 50. The input interface 53 may be connected to the second vehicle 50 as an external input device, instead of being provided in the second vehicle 50. As a connection method, for example, any method such as Universal Serial Bus (USB), High-Definition Multimedia Interface (HDMI®), or Bluetooth® can be used.

The output interface 54 includes at least one interface for output. The interface for output is, for example, a display for outputting information in the form of images, or a speaker for outputting information in the form of audio, or the like. The display is, for example, a liquid crystal display (LCD) or an organic electro luminescent (EL) display. The output interface 54 outputs data obtained by the operations of the second vehicle 50. The output interface 54 may be connected to the second vehicle 50 as an external output device, instead of being provided in the second vehicle 50. As the connection method, any method such as USB, HDMI®, or Bluetooth® can be used.

The communication interface 55 includes at least one external communication interface. The interface for communication may be either a wired or wireless communication interface. For wired communication, the interface for communication is, for example, a Local Area Network (LAN) interface or Universal Serial Bus (USB). In the case of wireless communication, the interface for communication may include, for example, an interface compliant with a mobile communication standard such as Long Term Evolution (LTE), 4th generation (4G), or 5th generation (5G), or an interface compliant with short-range wireless communication such as Bluetooth®, or satellite communication, etc. The communication interface 55 receives data to be used for the operations of the second vehicle 50 and transmits data obtained by the operations of the second vehicle 50.

The positioner 56 includes one or more sensors or receivers for acquiring the position information of the first vehicle 40 by GNSS (Global Navigation Satellite System) or the like. The GNSS receiver includes, for example, at least one of Global Positioning System (GPS), Quasi-Zenith Satellite System (QZSS), BeiDou, Global Navigation Satellite System (GLONASS), and Galileo.

### Operations of Information Processing Apparatus

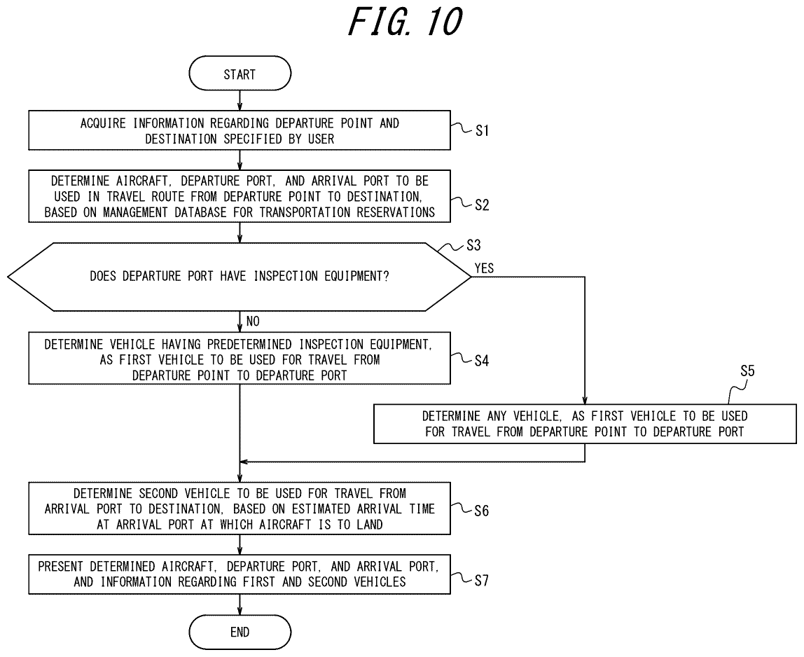

Operations of the information processing apparatus 10 according to the present embodiment will be described with reference to FIG. 10.

Step S1: The controller 11 of the information processing apparatus 10 acquires information regarding the departure point and destination specified by the user.

Any method can be employed for the process of acquiring information regarding the departure point and destination specified by the user. For example, the controller 11 may acquire information regarding the departure point and destination specified by the user from terminal apparatus 20 or the like via communication interface 15 and network 60.

Step S2: The controller 11 determines the aircraft, departure port, and arrival port used in the travel route from the departure point to the destination specified by the user based on a management database for transportation reservations.

Any method can be employed for such determination processing. For example, if the management database 120 illustrated in FIG. 5 is stored in the memory 12, the controller 11 may execute the determination processing based on the aircraft table 121 and port table 122. Specifically, the controller 11 may determine the aircraft 30, departure port, and arrival port used in the travel route considering various information. Various information may include aircraft information, aircraft usage information, port information, port usage information, environmental information, and so on. Environmental information includes weather, wind speed, temperature, atmospheric pressure, precipitation, visibility, and the condition of the port. The condition of the port includes whether the departure port or arrival port is wet, frozen, etc. In the prediction of environmental information, a learning model may be used as appropriate. In this case, past weather data, observation data around the departure port, and seasonal weather trends can be used as training data to improve prediction accuracy. Specifically, it becomes possible to analyze weather patterns, predict changes in wind direction and speed, and identify factors affecting takeoff. Additionally, by incorporating real-time data into the learning model, changes in weather conditions can be quickly reflected. The learning model is a model created by machine learning using machine learning algorithms. The learning model may be a machine learning model constructed based on decision trees, for example. A machine learning model constructed based on decision trees includes, for example, Light GBM, XGBoost, etc., but is not limited to these. Alternatively, the learning model may be a model generated based on machine learning algorithms such as Convolutional Neural Network (CNN), Recurrent Neural Network (RNN), or other deep learning methods.

More specifically, for example, the controller may determine the aircraft, departure port, and arrival port based on the current location information of the aircraft, current usage status, operation reservations, location of the port, reservation status of the port, weather, etc. The controller may select an appropriate travel route from among multiple travel routes if there are several available. Any method can be adopted for the selection of the travel route. For example, such methods include prioritizing the shortest travel time, selecting travel routes that avoid congestion and emphasize comfort, or prioritizing routes with lower travel costs. These selection criteria should be flexibly changed according to the purpose, situation, etc. User attribute information may be utilized in the selection of the travel route. User attribute information may include information on past travel history, user preferences, habits, and travel purposes (commuting, tourism, etc.). Additionally, priority conditions set by the user in advance (for example, reducing travel costs, shortening required time, or requests to include specific waypoints) may be considered. These allow for more appropriate route selection, enhancing user convenience and satisfaction.

Step S3: The controller determines whether the departure port has the predetermined inspection equipment. If the departure port has predetermined inspection equipment, the process proceeds to step S4. On the other hand, if the departure port does not have predetermined inspection equipment, the process proceeds to step S5.

Any method can be employed for such determination processing. For example, if the management database 120 illustrated in FIG. 5 is stored in the memory 12, the controller 11 may determine the presence or absence of predetermined inspection equipment at the departure port decided in step S2 based on the port table 122.

Step S4: The controller 11 determines the first vehicle 40 to be used for the movement from the departure point to the departure port as a vehicle having predetermined inspection equipment.

Step S5: The controller 11 determines any vehicle to be used for the movement from the departure point to the departure port as the first vehicle 40. Any vehicle includes both vehicles having predetermined inspection equipment and those not having predetermined inspection equipment.

Step S6: The controller 11 determines the second vehicle 50 to be used for the movement from the arrival port where the aircraft 30 is to land to the destination based on the estimated arrival time at the arrival port.

Step S7: The controller 11 presents route information regarding the determined aircraft 30, departure port, arrival port, first vehicle 40, and second vehicle 50.

Any method can be employed to present the route information. For example, the controller 11 may present such information via a user interface displayed by the output interface 24 of the terminal apparatus 20.

As described above, the information processing apparatus 10 acquires information regarding the departure point and destination specified by the user. The information processing apparatus 10 also determines the aircraft 30, departure port, and arrival port used in the travel route from the departure point to the destination based on a management database for transportation reservations. The information processing apparatus 10 also determines the first vehicle 40 used for the movement from the departure point to the departure port based on inspection equipment information regarding the departure port.

According to such a configuration, the aircraft 30 used in the travel route based on the management database for transportation reservations is determined along with the departure point and destination specified by the user, and the first vehicle 40 is determined based on the inspection equipment information regarding the departure port. Therefore, in terms of determining the optimal aircraft 30 and first vehicle 40 according to the travel route, the technology for providing Flying Mobility services is improved.

As mentioned above, the controller 11 may determine the second vehicle 50 to be used for the movement from the arrival port to the destination based on the estimated arrival time at the arrival port where the aircraft is to land. According to such a configuration, the optimal second vehicle 50 for the movement from the arrival port to the destination is determined.

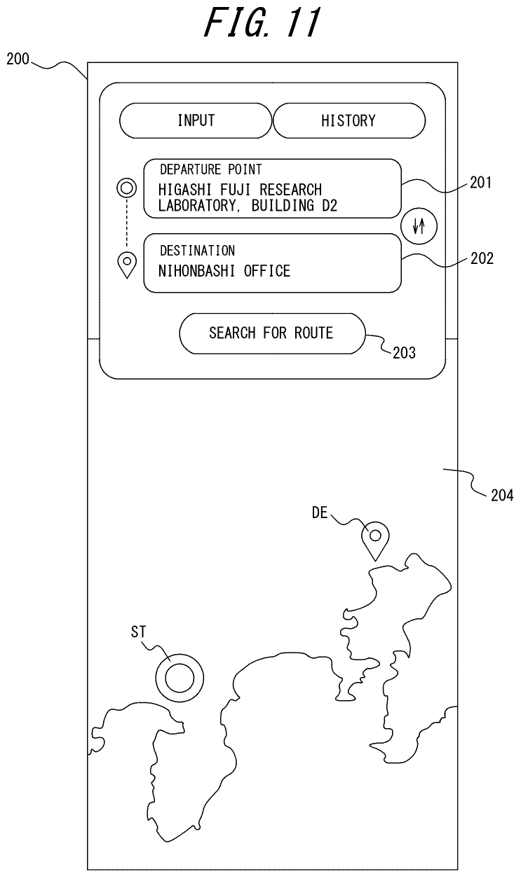

In the above processing, the user interface displayed by the output interface 24 of the terminal apparatus 20 may be used. Referring to FIGS. 11 to 13, various processes in the above processing will be described.

Referring to FIG. 11, an example of a user interface displayed to allow the user to specify information regarding the departure point and destination will be described. The user interface 200 shown in FIG. 11 includes a departure point specification field 201, a destination specification field 202, a decision button 203, and map information 204. The departure point specification field 201 and the destination specification field 202 are objects for the user to input and specify the departure point and destination. When the decision button 203 is operated by the user, the information of the departure point and destination specified by the user is sent to the information processing apparatus 10, and the aforementioned processing is executed. Map information 204 is an object for visually displaying the positions of the departure point and destination specified in the departure point specification field 201 and the destination specification field 202.

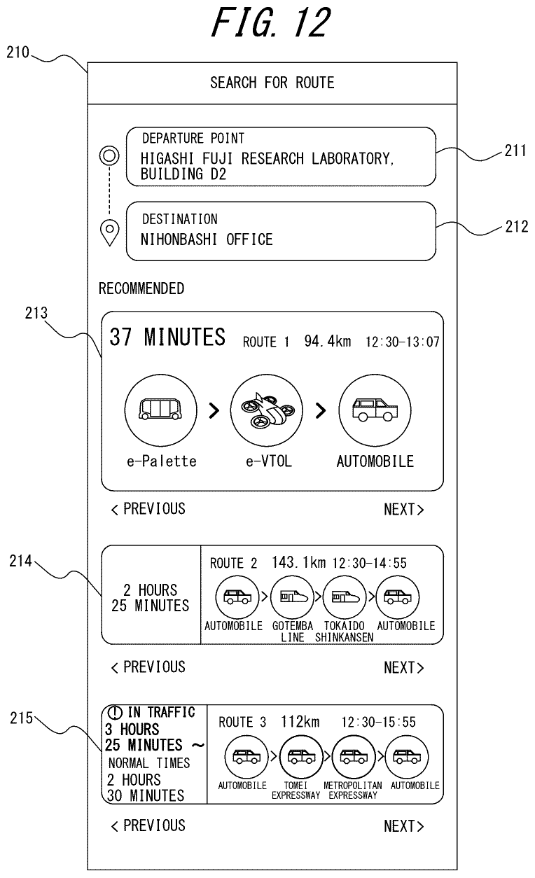

Referring to FIG. 12, an example of a user interface for presenting route information related to the determined aircraft, departure port, arrival port, first vehicle, and second vehicle will be described. The user interface 210 shown in FIG. 12 includes departure point information 211, arrival point information 212, route information 213, alternative route information 214, and alternative route information 215. Departure point information 211 and arrival point information 212 are objects that display the departure point and arrival point specified by the departure point specification field 201 and the destination specification field 202 of the user interface 200. Route information 213 is an object that presents the travel route based on the aircraft 30, departure port, arrival port, first vehicle 40, and second vehicle 50 determined by the above steps S2 to S6. Alternative route information 214 and alternative route information 215 are information on travel routes different from route information 213. Alternative route information 214 and alternative route information 215 are objects that may be presented when there are multiple travel routes. Alternative route information 214 and alternative route information 215 may also be determined by the above steps S2 to S6, similar to route information 213.

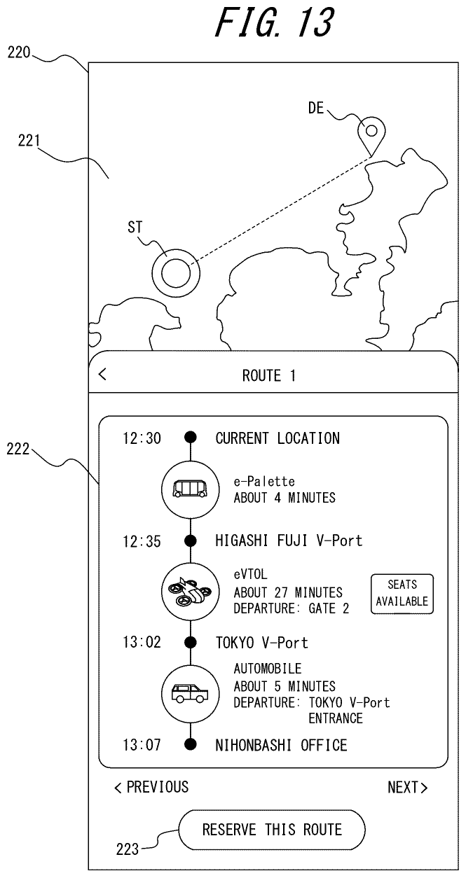

Referring to FIG. 13, an example of a user interface for presenting details of route information will be described. The user interface 220 shown in FIG. 13 includes map information 221, route detail information 222, and a reservation button 223. For example, the user interface 220 may be displayed when the route information 213 of the user interface 210 is selected by the user. Map information 221 is an object for visually displaying the positions of the departure point and destination specified in the user interface 200. Route detail information 222 is an object that presents details of the travel route based on the aircraft 30, departure port, arrival port, first vehicle 40, and second vehicle 50 determined by the above steps S2 to S6. The reservation button 223 is a button for executing the reservation process for the movement based on the displayed route information 213. When the reservation button 223 is selected by the user, processing related to the arrangement of the aircraft 30 and the dispatch processing of the first vehicle 40 and second vehicle 50 is executed. If the first vehicle 40 is an autonomous vehicle, when the reservation button 223 is selected by the user, the first vehicle 40 may be automatically controlled to arrive at the departure point by the departure time. Similarly, if the second vehicle 50 is an autonomous vehicle, when the reservation button 223 is selected by the user, the second vehicle 50 may be automatically controlled to arrive at the arrival port by the landing time.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, in the above step S4, it was decided that the first vehicle 40, which has predetermined inspection equipment, is used for the movement from the departure point to the departure port, and in this case, processing related to the boarding procedure for the aircraft 30 after passing the inspection by the predetermined inspection equipment of the first vehicle 40 (hereinafter referred to as check-in processing) may be executed. By executing the check-in process in the first vehicle 40, smooth boarding procedures to the aircraft 30 can be achieved. In other words, after the first vehicle 40 arrives at the departure port, the user can immediately board the aircraft 30.

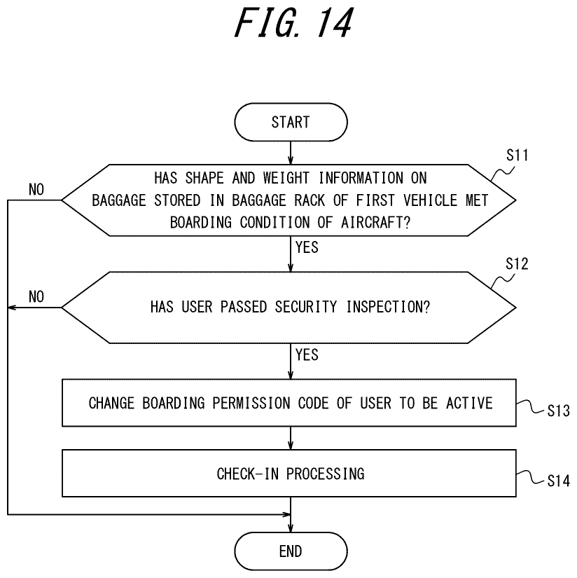

Referring to FIG. 14, the operation related to the check-in process when the predetermined inspection equipment includes baggage inspection equipment and security inspection equipment will be described.

Step S11: The controller 11 of the information processing apparatus 10 determines whether the shape and weight information of the baggage stored in the baggage rack of the first vehicle 40 meets the boarding conditions of the aircraft 30. The shape of the baggage includes the size of the baggage. The size of the baggage may be the total length of the baggage's length, width, and height. If the shape and weight information of the baggage meets the boarding conditions of the aircraft 30, the process proceeds to step S12. If the shape and weight information of the baggage does not meet the boarding conditions of the aircraft 30, the process ends.

Any method can be employed for such determination processing. For example, the baggage rack may be equipped with weight sensors and shape measurement sensors, and the shape and weight information of the user's baggage loaded on the baggage rack may be measured by the weight sensors and shape measurement sensors. The controller 11 may receive the measured shape and weight information of the baggage from the first vehicle 40 via the communication interface 15 and the network 60. The controller 11 may determine whether the received shape and weight information of the baggage meets the boarding conditions of the aircraft 30.

Step S12: The controller 11 determines whether the user has passed the security inspection. If the user has passed the security inspection, the process proceeds to step S13. If the user has not passed the security inspection, the process ends.

Any method can be employed for such determination processing. For example, the first vehicle 40 may be equipped with metal detection sensors, weight sensors, etc., and the presence of metal objects held by the user and the user's weight may be measured by the metal detection sensors and weight sensors. The controller 11 may receive information on the presence of metal objects, weight information, etc., from the first vehicle 40 via the communication interface 15 and the network 60. The controller 11 may determine whether the boarding conditions of the aircraft 30 are met based on the information on the presence of metal objects, weight information, etc.

Step S13: The controller 11 actively changes the user's boarding permission code. The boarding permission code is a code such as a two-dimensional code that the user presents to the code reading device during the check-in process. The check-in process is executed by presenting the boarding permission code to the code reading device. The code reading device is provided in the first vehicle 40.

Step S14: The controller 11 performs check-in processing. Specifically, the controller 11 may receive information about the boarding permission code read by the code reading device via the communication interface 15 and network 60. The controller 11 executes check-in processing based on that information. If the check-in processing is completed, the controller 41 of the first vehicle 40 may output a completion voice for the check-in processing via the output interface 44. The completion voice of the check-in processing allows the user to easily understand that the check-in processing has been completed.

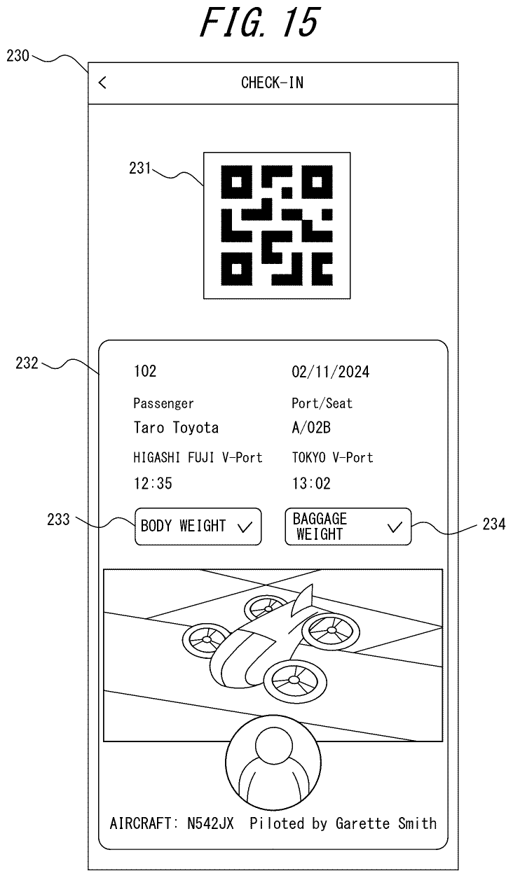

Referring to FIG. 15, an example of a user interface related to the check-in processing will be described. The user interface 230 shown in FIG. 15 includes the boarding permission code 231, boarding information 232, security inspection result information 233, and baggage inspection result information 234. The boarding permission code 231 is a code such as a two-dimensional code that the user presents to the code reading device during check-in processing, as mentioned above. The boarding information 232 is information related to the user's movement by the aircraft 30. The boarding information 232 includes, for example, the date of boarding, the name of the passenger, the departure port, the seat number, the departure time from the departure port, and the arrival time at the arrival port. The security inspection result information 233 is information related to the results of the security inspection determined in step S12. If the security inspection is passed, a check mark is attached. The baggage inspection result information 234 is information related to the results of the baggage inspection determined in step S11. If the baggage inspection is passed, a check mark is attached. For example, if both the security inspection and baggage inspection are passed, the boarding permission code 231 may be displayed in a readable manner, thereby activating the user's boarding permission code. By doing so, the user can visually confirm the progress of the boarding procedure. In addition, it becomes possible for related parties such as pilots, operators, and other administrators to easily manage the status of boarding permission. Moreover, by clearly displaying the status of the boarding permission code, it is also expected to prevent incorrect boarding and unauthorized boarding. The boarding permission code 231 being displayed in a readable manner includes changing the boarding permission code 231 from a grayed-out state to black, and displaying the boarding permission code 231 from a hidden state to visible.

In the operation related to the check-in processing illustrated in FIG. 15, it was described that the predetermined inspection equipment includes both baggage inspection equipment and security inspection equipment, but this is not limited to that; it is the same even if it is only one of them. For example, the predetermined inspection equipment may be only baggage inspection equipment that measures the shape and weight information of baggage stored in the baggage rack of the first vehicle 40. In this case, the controller 11 of the information processing apparatus 10 may change the boarding permission code of the user to be active if the shape and weight information of the baggage stored in the baggage rack of the first vehicle 40 meets the boarding conditions of the aircraft 30. Based on the active boarding permission code, the controller 11 may execute the check-in process. On the other hand, for example, the predetermined inspection equipment may be only security inspection equipment. In this case, the controller 11 may change the boarding permission code of the user to be active when the user has passed security inspection, and based on the active boarding permission code, may execute the check-in process.

Also, for example, based on the user's boarding information, the storage location of the user's baggage in the baggage rack of the first vehicle 40 may be predetermined. For example, in the case where user A and user B board, the storage locations of user A and user B's baggage may be determined as the far right and far left of the baggage rack, respectively. The storage locations may be determined based on the shape, weight, etc., of each user's baggage. For example, at the stage of step S7 mentioned above, the controller 11 may determine the location where the user will store their carry-on baggage and present this information to the user along with route information. This allows the user to store their carry-on baggage in a predetermined storage location. Also, this allows for clearly identifying the owner of each piece of baggage during the transfer operation from the first vehicle 40 to the aircraft 30. For example, if the transfer operation is performed manually by the pilot, having predetermined storage locations for the baggage can reduce the time required for identifying and handling each piece of baggage. Additionally, even when the transfer operation is performed by a robot or automated machine, if the storage locations and owner information are linked in advance, the robot can autonomously handle the baggage accurately, improving the accuracy and efficiency of the operation.

Also, for example, the controller 11 may estimate the takeoff possibility regarding the possibility of takeoff from the departure port at the scheduled takeoff time of the aircraft 30. Furthermore, the controller 11 may present the takeoff possibility to the user. This allows the user to understand the possibility of moving along a predetermined travel route and to decide whether to change the route in advance. Any method may be adopted for the estimation process of the takeoff possibility. For example, the controller 11 may estimate the takeoff possibility by predicting the environmental information of the departure port at the time of departure. Environmental information includes weather, wind speed, temperature, atmospheric pressure, precipitation, visibility, and the condition of the port. The condition of the port includes whether the departure port is wet, frozen, etc. In predicting environmental information, a learning model may be used as appropriate. In this case, past weather data, observation data around the departure port, and seasonal weather trends can be used as training data to improve prediction accuracy. Specifically, it becomes possible to analyze weather patterns, predict changes in wind direction and speed, and identify factors affecting takeoff. Additionally, by incorporating real-time data into the learning model, changes in weather conditions can be quickly reflected. The learning model is a model created through machine learning using machine learning algorithms. The learning model may be a machine learning model constructed based on decision trees, for example. A machine learning model constructed based on decision trees includes, for example, Light GBM, XGBoost, etc., but is not limited to these. Alternatively, the learning model may be a model generated based on machine learning algorithms such as Convolutional Neural Network (CNN), Recurrent Neural Network (RNN), and other deep learning methods.

For example, if the takeoff possibility is below the first predetermined value (for example, less than 50%), the controller may present a proposal for changing the travel route. The proposal for changing the travel route may include a change of the departure port. This allows for avoiding the effects of bad weather, wind speed issues, etc., and achieving movement to a safe takeoff location.

Additionally, for example, the controller may estimate a landing possibility regarding whether the aircraft can land at the arrival port at a scheduled landing time. Furthermore, the controller may present the landing possibility to the user. This allows the user to understand the possibility of moving along a predetermined travel route and to decide whether to change the route in advance. Any method can be adopted for the estimation process of landing possibility. For example, the controller may estimate the landing possibility by predicting the environmental information of the arrival port at the time of arrival. Environmental information includes weather, wind speed, temperature, atmospheric pressure, precipitation, visibility, and the condition of the port. The state of the port includes conditions such as the arrival port being wet or frozen. In predicting environmental information, a learning model may be used as appropriate. In this case, past weather data, observation data around the departure port, and seasonal weather trends can be used as training data to improve prediction accuracy. Specifically, it becomes possible to analyze weather patterns, predict changes in wind direction and speed, and identify factors affecting landing. Additionally, by incorporating real-time data into the learning model, changes in weather conditions can be quickly reflected.

Additionally, for example, if the landing possibility is below the second predetermined value (for example, less than 50%), the controller may present a proposal for changing the travel route. The proposal for changing the travel route may include a change of the arrival port. This allows for avoiding the effects of bad weather, wind speed issues, etc., and achieving movement to a safe landing location.

For example, an embodiment in which the configuration and operations of the information processing apparatus 10 in the above embodiment are distributed to multiple computers capable of communicating with each other can be implemented. For example, an embodiment in which some or all of the components of the information processing apparatus 10 are provided in terminal apparatus 20, aircraft 30, first vehicle 40, second vehicle 50, etc. can also be implemented.

Examples of some embodiments of the present disclosure are described below. However, it should be noted that the embodiments of the present disclosure are not limited to these examples.

[Appendix 1] An information processing apparatus comprising a controller configured to:
acquire information regarding a departure point and a destination specified by a user;
determine an aircraft, a departure port, and an arrival port to be used in a travel route from the departure point to the destination, based on a management database for transportation reservations; and
determine a first vehicle to be used for travel from the departure point to the departure port, based on inspection equipment information regarding the departure port.

[Appendix 2] The information processing apparatus according to appendix 1 , wherein the controller is configured to determine, as the first vehicle, a vehicle having predetermined inspection equipment when the departure port has no predetermined inspection equipment.

[Appendix 3] The information processing apparatus according to appendix 2, wherein
the predetermined inspection equipment includes baggage inspection equipment configured to measure shape and weight information on baggage stored in a baggage rack of the first vehicle, and
the controller is configured to:
   when the shape and weight information on the baggage stored in the baggage rack of the first vehicle meets boarding conditions of the aircraft, change a boarding permission code of the user to be active; and
   perform check-in processing, based on the boarding permission code that has been changed to be active.

[Appendix 4] The information processing apparatus according to appendix 3, wherein the controller is configured to determine a storage location of baggage of the user in the baggage rack, based on boarding information on the user.

[Appendix 5] The information processing apparatus according to appendix 3 or appendix 4, wherein
the predetermined inspection equipment includes security inspection equipment, and
the controller is further configured to:
   when the user has passed security inspection, change the boarding permission code of the user to be active; and
   perform check-in processing, based on the boarding permission code that has been changed to be active.

[Appendix 6] The information processing apparatus according to any one of appendices 1 to 5, wherein the controller is configured to determine a second vehicle to be used for travel from the arrival port to the destination, based on an estimated arrival time at the arrival port at which the aircraft is to land.

[Appendix 7] The information processing apparatus according to appendix 1, wherein the controller is configured to:
estimate a takeoff possibility regarding whether the aircraft can take off from the departure port at a scheduled takeoff time; and
present the takeoff possibility.

[Appendix 8] The information processing apparatus according to appendix 7, wherein the controller is configured to present a proposal for changing the travel route when the takeoff possibility is less than a first predetermined value.

[Appendix 9] The information processing apparatus according to appendix 8, wherein the proposal for changing the travel route includes a change of the departure port.

[Appendix 10] The information processing apparatus according to any one of appendices 1 to 9, wherein the controller is configured to:
estimate a landing possibility regarding whether the aircraft can land at the arrival port at a scheduled landing time; and
present the landing possibility.

[Appendix 11] The information processing apparatus according to appendix 10, wherein the controller is configured to present a proposal for changing the travel route when the landing possibility is less than a second predetermined value.

[Appendix 12] The information processing apparatus according to appendix 11, wherein the proposal for changing the travel route includes a change of the arrival port.

[Appendix 13] A method for providing transportation performed by an information processing apparatus, the method comprising:
acquiring information regarding a departure point and a destination specified by a user;
determining an aircraft, a departure port, and an arrival port to be used in a travel route from the departure point to the destination, based on a management database for transportation reservations; and
determining a first vehicle to be used for travel from the departure point to the departure port, based on inspection equipment information regarding the departure port.

[Appendix 14] A program configured to cause a computer to execute operations, the operations comprising:
acquiring information regarding a departure point and a destination specified by a user;
determining an aircraft, a departure port, and an arrival port to be used in a travel route from the departure point to the destination, based on a management database for transportation reservations; and
determining a first vehicle to be used for travel from the departure point to the departure port, based on inspection equipment information regarding the departure port.

1. An information processing apparatus comprising a controller configured to:
acquire information regarding a departure point and a destination specified by a user;
determine an aircraft, a departure port, and an arrival port to be used in a travel route from the departure point to the destination, based on a management database for transportation reservations; and
determine a first vehicle to be used for travel from the departure point to the departure port, based on inspection equipment information regarding the departure port.

2. The information processing apparatus according to claim 1, wherein the controller is configured to determine, as the first vehicle, a vehicle having predetermined inspection equipment when the departure port has no predetermined inspection equipment.

3. The information processing apparatus according to claim 2, wherein
the predetermined inspection equipment includes baggage inspection equipment configured to measure shape and weight information on baggage stored in a baggage rack of the first vehicle, and
the controller is configured to:
when the shape and weight information on the baggage stored in the baggage rack of the first vehicle meets boarding conditions of the aircraft, change a boarding permission code of the user to be active; and
perform check-in processing, based on the boarding permission code that has been changed to be active.

4. The information processing apparatus according to claim 3, wherein the controller is configured to determine a storage location of baggage of the user in the baggage rack, based on boarding information on the user.

5. The information processing apparatus according to claim 3, wherein
the predetermined inspection equipment includes security inspection equipment, and
the controller is further configured to:
when the user has passed security inspection, change the boarding permission code of the user to be active; and
perform the check-in processing, based on the boarding permission code that has been changed to be active.

6. The information processing apparatus according to claim 1, wherein the controller is configured to determine a second vehicle to be used for travel from the arrival port to the destination, based on an estimated arrival time at the arrival port at which the aircraft is to land.

7. The information processing apparatus according to claim 1, wherein the controller is configured to:
estimate a takeoff possibility regarding whether the aircraft can take off from the departure port at a scheduled takeoff time; and
present the takeoff possibility.

8. The information processing apparatus according to claim 7, wherein the controller is configured to present a proposal for changing the travel route when the takeoff possibility is less than a first predetermined value.

9. The information processing apparatus according to claim 8, wherein the proposal for changing the travel route includes a change of the departure port.

10. The information processing apparatus according to claim 1, wherein the controller is configured to:
estimate a landing possibility regarding whether the aircraft can land at the arrival port at a scheduled landing time; and
present the landing possibility.

11. The information processing apparatus according to claim 10, wherein the controller is configured to present a proposal for changing the travel route when the landing possibility is less than a second predetermined value.

12. The information processing apparatus according to claim 11, wherein the proposal for changing the travel route includes a change of the arrival port.

13. A method for providing transportation performed by an information processing apparatus, the method comprising:
acquiring information regarding a departure point and a destination specified by a user;
determining an aircraft, a departure port, and an arrival port to be used in a travel route from the departure point to the destination, based on a management database for transportation reservations; and
determining a first vehicle to be used for travel from the departure point to the departure port, based on inspection equipment information regarding the departure port.

14. A non-transitory computer readable medium storing a program configured to cause a computer to execute operations, the operations comprising:
acquiring information regarding a departure point and a destination specified by a user;
determining an aircraft, a departure port, and an arrival port to be used in a travel route from the departure point to the destination, based on a management database for transportation reservations; and
determining a first vehicle to be used for travel from the departure point to the departure port, based on inspection equipment information regarding the departure port.
